(19) United States
(12) Patent Application Publication
(10) Pub. No.: US 2005/0206874 A1
(43) Pub. Date: Sep. 22, 2005

(54) Apparatus and method for determining the range of remote point light sources

(76) Inventor: Robert P. Dougherty, Bellevue, WA (US)

Correspondence Address: GARY C. COHN, PLLC, 1147 NORTH FOURTH STREET, UNIT 6E, PHILADELPHIA, PA, 19123, US

(21) Appl. No.: 10/805,504

(22) Filed: Mar. 19, 2004

(51) Int. Cl. G01C 3/08; G01B 11/24; G01B 11/30

(52) U.S. Cl. 356/4.05; 356/4.01; 356/4.03; 356/4.04

(57) ABSTRACT

Ranges and transverse coordinates of point light sources are estimated by forming an out-of-focus image of the point light sources using a camera. The out-of-focus image is formed such that it is imaged as a disk or ring having a bright periphery. This is conveniently achieved by taking advantage of under- or overcorrected spherical aberration in the lens, or of diffraction effects caused by the interaction of light with the aperture of the lens. Range estimates can be calculated from a size metric of the disk or ring, which in turn can be accurately determined due to its bright periphery. Range estimates can also be obtained using certain pattern matching methods.

### BACKGROUND OF THE INVENTION

The present invention relates to apparatus and methods for optical image acquisition and analysis. In particular, it relates to passive techniques for measuring the range of objects that represent point light sources.

In many fields such as robotics, autonomous land vehicle navigation, surveying, destructive crash testing, virtual reality modeling and many other applications, it is desirable to rapidly estimate the locations of all visible objects in a scene in three dimensions.

A number of methods are available for providing range estimates. Various active techniques include radar, sonar, scanned laser and structured light methods. These techniques all involve transmitting energy to the object and monitoring the reflection of that energy. Range information can be obtained using a conventional camera, if the object or the camera is moving a known way. There are various passive optical techniques that can provide range information, including both stereo and focus methods. Examples of these methods are described in U.S. Pat. Nos. 5,365,597, 5,793,900 and 5,151,609. In WO 02/08685, I have described a passive method for estimating ranges of objects, in which incoming light is split into multiple beams, and multiple images are projected onto multiple CCDs. The CCDs are at different optical path lengths from the camera lens, so that the image is focused differently on each of the CCDs. Ranges are then calculated from a focus metric indicative of the degree to which an object is in focus on two or more of the image sensors. The focus metric may be related to the differences in the diameters of blur circles formed when a point light source is imaged out of focus on two or more CCDs. In this process, the blur circles have a brightness that is most intense at the center and diminishes rapidly towards the edges of the circle. As a result, it is often difficult to ascertain the boundaries of the blur circle with precision.

In my U.S. Pat. No. 6,616,347, I have described another passive method of estimating ranges of objects using a camera. This method also relies on comparing multiple images of the object, and comparing the images to infer the range of the object. In this approach, the range is inferred from the differences in the position of the object on the CCD in the different images.

Many of the foregoing methods are less useful when the object under consideration is point light source. However, in many applications, it is desirable to measure the range of a point light source.

Thus, it would be desirable to provide a simplified method by which ranges of point light sources can be determined rapidly and accurately under a wide variety of conditions. It is further desirable to perform this range-finding using relatively simple, portable equipment.

### SUMMARY OF THE INVENTION

This invention is a method for determining the range of one or more point light sources, comprising
(a) forming an out-of-focus image of the point light source on an image sensor of a camera having a focusing means, such that the point light source is imaged at a position on the image sensor as a predetermined form having a distinct periphery, and
(b) calculating an estimated range of the point light source from the image of the point light source on the image sensor.

The distinct periphery of the imaged form allows one to use various image processing methods to accurately identify images that correspond to a remote point light source, and to very precisely determine a size metric and the position of the image. These accurate measurements allow one to calculate excellent estimates of the range of the point light source. In addition, information concerning the location of the image on the image sensor allows one to develop estimates of the position of the point light source transverse to the optical axis of the camera.

Two preferred methods of calculating range estimates are provided. In the first preferred method, at least one size metric of the image is determined and the range of the point light source is calculated from that size metric. In the second preferred method, various distances for the point light source are postulated, and the characteristics (size and shape) of the corresponding image on the image sensor are calculated for each such postulated distance. These calculated images are compared with actual images on the image sensor. Matches between actual and calculated images indicate the distance of the point light source.

In a second aspect, this invention is a camera comprising a focusing means and an image sensor, wherein the focusing means is capable of forming an out-of-focus image of a remote point light source such that the point light source is imaged on the image sensor as a predetermined form having a distinct periphery, and computer means for identifying said predetermined form and calculating an estimate of the range of the point light source from the predetermined form.

### BRIEF DESCRIPTION OF THE DRAWINGS

FIG. 1 is a schematic illustrating ray convergence for a well corrected camera lens.

FIG. 2 is a schematic illustrating ray convergence for an undercorrected camera lens having spherical aberration. FIG. 2A is a schematic illustrating how the camera lens of FIG. 2 images a point light source.

FIG. 3 is a schematic illustrating ray convergence for an overcorrected camera lens having spherical aberration.

FIG. 4 is a schematic of a modified camera lens for imaging a point light source as a bright ring.

FIG. 5 is a schematic of a modified camera lens for producing diffraction effects that result in point light sources being imaged as rings having a bright periphery.

FIG. 6 is a schematic illustrating the relationship between the position of the imaged ring on an image sensor and the transverse coordinates of a point light source in space.

### DETAILED DESCRIPTION OF THE INVENTION

An out-of focus light point source is imaged as a “blur circle” by a camera having a circular aperture or iris). In general, the approximate shape of the “blur circle” will be determined by the shape of the aperture or iris of the lens, and thus the point light source will be imaged in a predetermined form that is mainly defined by the aperture or iris configuration. Depending on camera optics and object location, this “blur circle” can be circular, elliptical, figure-8-shaped, a polygon, a “cross” or “T”-shape, or some other, more or less regular shape. The size of the blur circle can be used to estimate the range of the point source. In order to obtain a good value of the size of this blur circle, in this invention the blur circle is imaged with a distinct periphery. In preferred methods, the blur circle is imaged with a bright periphery, i.e., the periphery of the blur circle is brighter than adjacent areas inside and outside of the blur circle. The distinct periphery, and a bright periphery in particular, permits the size of the blur circle to be measured reliably, and therefore allows good range estimates to be calculated. The position of the blur circle on the image sensor also allows the transverse position of the point source, relative to the optical axis of the camera, to be calculated.

There are several ways to image out-of focus point sources as blur circles with distinct or bright peripheries. A lens that has undercorrected spherical aberration will image a point source as a bright ring, if the focus distance is closer to the camera than the point source. A lens having overcorrected spherical aberration with image the point source as a bright ring if the focus distance is farther from the camera than the light source. Diffraction methods can also form the requisite bright-ringed image.

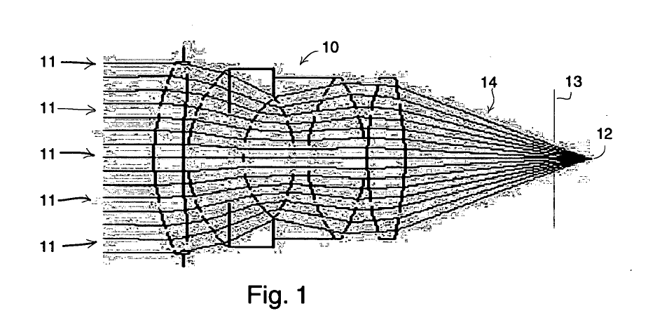

FIGS. 1, 2 and 3 illustrate how bright rings are formed as a result of spherical aberration. In FIG. 1, light rays 11 passing through a well-corrected lens 10 are focused at point 12. Light rays from a point source are focused by lens 10 into cone 14. Because the lens is well-corrected, light rays passing through various portions of lens 10 converge only at point 12. An image sensor located at position 13 will image the point source as a blur circle. The illumination of the blur circle can be uniform but generally diminishes towards its periphery.

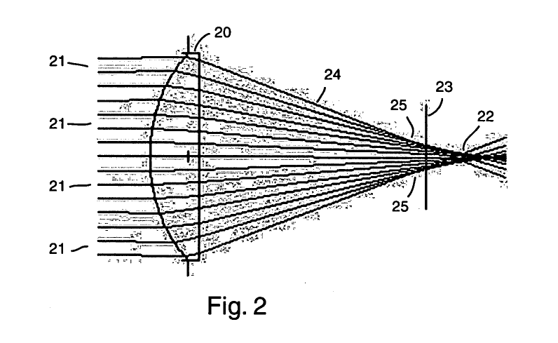

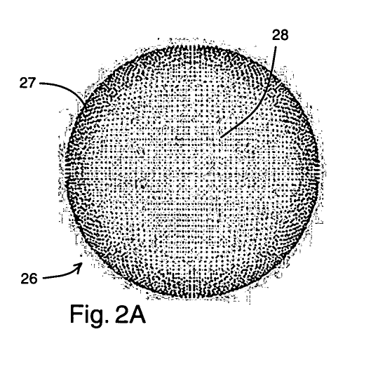

In FIG. 2, lens 20 has undercorrected spherical aberration. Light rays 21 passing through lens 20 again form a light cone that in this case is best focused at point 22. However, the spherical aberration caused by the lens causes light passing through the periphery of the lens to be focused somewhat in front of point 22. This causes light rays from outer portions of the lens to cross at the surface of light cone 24, in front of the image sensor, forming a “caustic” in the region indicated by reference numeral 25. An image sensor located within region 25, such at position 23, will image the point source as a blur circle having a brightened periphery due to its intersection of the caustic. FIG. 2A illustrates the appearance of such a blur circle. In FIG. 2A, the point source is imaged as blur circle 26. Blur circle 26 has a bright periphery 27 and a less bright central portion 28. Periphery 27 is used in this invention to determine the size and position of blur circle 26 and determine the range and position of the point source imaged as blur circle 26.

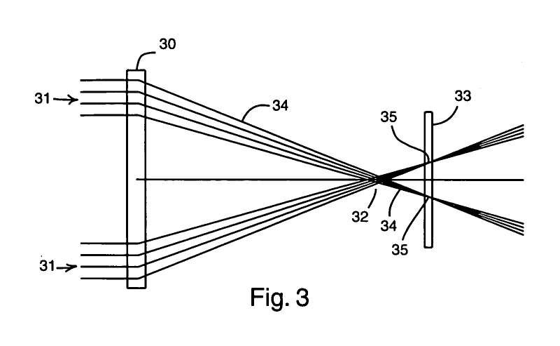

FIG. 3 shows how a similar effect is created using a lens having overcorrected spherical aberration. In this case, light rays 31 pass through lens 30, forming light cone 34 that is best focused at point 32. In this case, the overcorrected spherical aberration causes light passing through the periphery of the lens to be focused somewhat behind point 32. Again, a “caustic” region is formed, this time in the region indicated by reference numeral 35, in which light rays cross to brighten the periphery of light cone 34. Image sensor 33 located in region 35 will image the point source as a blur circle with a bright periphery, similar to that shown in FIG. 2A. The image sensor in this case is behind the region of best focus 32, i.e., the camera is focused to a distance closer than the actual distance of the point source to the camera.

Many commercially available camera lenses that have over- or under corrected spherical aberration can be used in the invention. 6-element Biotar (also known as double Gauss-type) lenses often exhibit a small amount of spherical aberration. An example of a commercially available lens having undercorrected spherical aberration is Nikkor 50 mm/f=1.4 lens. A commercially available lens having overcorrected spherical aberration is Canon EF 35 mm/f=2 lens.

Lenses may be modified to increase spherical aberration either by overcorrecting or undercorrecting. A simple plano-convex lens with curved side facing forward also produces useful spherical aberration.

Techniques for designing lenses, including compound lenses, are well known and described, for example, in Smith, “Modern Lens Design”, McGraw-Hill, New York (1992). Methods described there are useful for making specific lens design modifications to obtain desired spherical aberration. In addition, lens design software programs can be used to design the focussing system, such as OSLO Light (Optics Software for Layout and Optimization), Version 5, Revision 5.4, available from Sinclair Optics, Inc.

When spherical aberration is used to produce the rings, the light rays entering the periphery of the lens are most important. As spherical aberration becomes greater with increasing lens diameter, higher diameter lenses are preferred, particularly those with an f-number of about 3 or less, preferably 2 or less, more preferably 1.5 or less. Large diameter lenses also give better range measurement accuracy because of blur circle size becomes more sensitive to object distance as lens diameter increases.

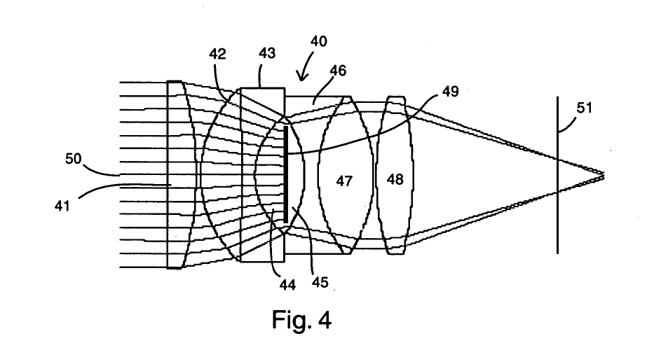

As seen in FIG. 2A, light rays passing near the center of the lens do not contribute to the brightness of the peripheral ring, but instead illuminate the center of the ring. To improve the contrast between the ring and adjacent areas, it is useful to block out light rays entering near the center of the lens. This is conveniently done by covering a central region of the lens, as shown in FIG. 4. In FIG. 4, double Gauss lens 40 is modified by removing the original front element and replacing it with plano-convex lens 41 (with flat side facing forward). Elements 42-43 and 46-48 complete the lens. Between air gaps 44 and 45, mask 49 is inserted to block light passing near the optical axis 50 of the lens. This allows only that light passing through the periphery of lens 40 to reach image sensor 51. This causes the point light source to be imaged as a ring with a dark center. The resulting increased contrast between ring and surrounding regions makes it easier to identify the rings and develop metrics useful to estimate the position of the light source.

Diffraction effects can also cause point light sources to be imaged as rings with a bright periphery. Light interacts at the edges of an aperture in the lens to produce a diffraction effect. This causes point light sources to be imaged as rings that take the shape of the aperture. This method has the advantages of producing rings of known shape, and of showing little distortion in images that are near the edges of the field of view. The size of the rings is related to the aperture diameter and range of the point source. These rings tend to be fainter than those formed by spherical aberration, so a brighter light source is sometimes needed.

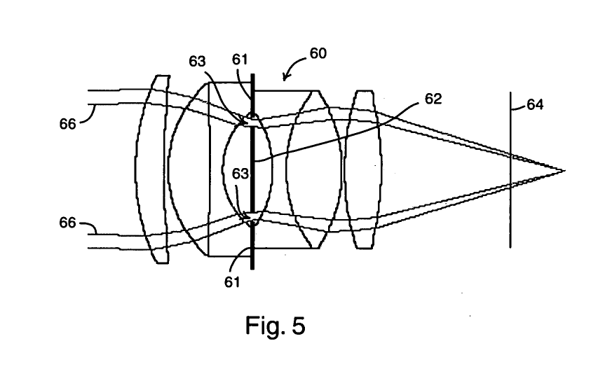

Errors in range estimates tend to decrease with increasing ring size. In the diffraction technique, ring size increases with increasing aperture size, but this diminishes the brightness of the ring. The contrast between the ring and adjacent areas can be improved by filtering out unwanted light. This is conveniently done by masking the center of the lens, and preferably the periphery of the lens, to form a narrow, annular slit. The slit allows that light which forms the diffraction ring to reach the image sensor, while eliminating most or all other light. An example of this is illustrated in FIG. 5. In FIG. 5, lens 60 has a central mask 62 and an annular mask 61 that block light from entering the camera except through regions 63. Regions 63 contain the diffracted light that forms the desired ring images on image sensor 64. Lines 66 indicate the pathway of light from a distant point source through lens 60 to image sensor 64.

The point light source can be imaged in a wide variety of predetermined forms by selecting a corresponding aperture and/or iris shape, or by masking the lens to create an opening for light that has a desired shape. Imaging the point light sources as shapes other than circles or rings may improve accuracy in some instances. For example, in some cases it may be difficult to distinguish blur circles or rings produced from the point light sources from other content in the image. This problem may be reduced by producing the image of the point light source in some other predetermined form, such as a polygon or cross, that is more unique and can be easily identified by image processing software. Point light sources are imaged (as described above) on an image sensor, and are generally captured to permit image processing. By “capturing an image”, it is meant that the image is stored in some reproducible form, by any convenient means. For example, the image may be captured on photographic film. However, making range calculations from photographic prints or slides will generally be slow and less accurate. Thus, it is preferred to capture the image as an electronic data file, especially a digital file, which can be read to any convenient type of memory device. The brightness values are preferably stored as a digital file that correlates brightness values with particular pixel locations. Commercially available digital still and video cameras include microprocessors programmed with algorithms to create such digital files; such microprocessors are entirely suitable for use in this invention. Among the suitable commercially available algorithms are TIFF, JPEG, MPEG and Digital Video formats.

The data in the digital file is amenable to processing to perform automated range calculations using a computer. The preferred image sensor, then, is one that converts the image into electrical signals that can be processed into an electronic data file. It is especially preferred that the image sensor contains a regular array of light-sensing units (i.e. pixels) of known and regular size. The array is typically rectangular, with pixels being arranged in rows and columns. CCDs, CMOS devices and microbolometers are examples of the especially preferred image sensors. These especially preferred devices permit light received at a particular location on the image sensor to be identified with a particular pixel at a particular physical location on the image sensor. Suitable CCDs are commercially available and include those types that are used in high-end digital photography or high definition television applications. The CCDs may be color or black-and-white. The CCDs may also be sensitive to wavelengths of light that lie outside the visible spectrum. For example, CCDs adapted to work with infrared radiation may be desirable for night vision applications. Long wavelength infrared applications are possible using microbolometer sensors and LWIR optics.

Particularly suitable CCDs contain from about 100,000 to about 30 million pixels or more, each having a largest dimension of from about 3 to about 20, preferably about 5 to about 13 μm. A pixel spacing of from about 3-30 μm is preferred, with image sensors having a pixel spacing of 5-10 μm being more preferred. Commercially available CCDs that are useful in this invention include those of the type commonly available on consumer still and movie digital cameras. Sony's ICX252AQ CCD, which has an array of 2088×1550 pixels, a diagonal dimension of 8.93 mm and a pixel spacing of 3.45 μm; Kodak's KAF-2001CE CCD, which has an array of 1732×1172 pixels, dimensions of 22.5×15.2 mm and a pixel spacing of 13 μm; and Thomson-CSF TH7896M CCD, which has an array of 1024×1024 pixels and a pixel size of 19 μm, are examples of suitable CCDs. CCDs adapted for consumer digital video cameras are especially suitable.

In addition to the components described above, the camera will also include a housing to exclude unwanted light and hold the components in the desired spatial arrangement. The optics of the camera may include various optional features, such as a zoom lens; an adjustable aperture; an adjustable focus; filters of various types, connections to power supply, light meters, various displays, and the like.

Images formed in the manner described above are processed to (1) identify image corresponding to the remote point light source(s), (2) develop at least one size metric indicative of the size of the image, and (3) calculate a range estimate for the light source from at least one of the developed size metrics. It is further possible to estimate the transverse position of the point light source, once range is estimated, by (1) identifying at least one image position metric indicative of the position of the image on the image sensor relative to the optical axis of the camera, and (2) calculating the transverse position of the point light source from the range estimate and the position metric(s). The following methods are described in relation to point light sources that are imaged as circular or elliptical rings having a bright periphery, but these methods are also applicable to images have other predetermined forms.

Imaged rings can be identified by examining groups of pixels to identify bright areas that may correspond to points on the ring, and then identifying rings which are formed by the identifying bright areas. It is preferred to apply some smoothing to the brightness values, such as a Gaussian smoothing over 3-5 pixels, before identifying the positions of the rings. Any point on the imaged ring will be brighter than points on adjacent pixels.

Images may contain light from sources other than the point source(s) being analyzed, and in such case methods can be used to distinguish points on imaged rings from random light points or points at which other objects are imaged. On such method evaluates brightness changes within groups of pixels. For a ring point, the rate at which brightness changes will be greatest is in a direction normal to the ring at that point. That rate of change will be smallest in a direction tangent to the ring. Pixels exhibiting this pattern can be identified by calculating a Hessian second derivative for each pixel in the composite image, and evaluating the Hessian second derivatives using the Sobel convolution operators

$$\frac{\partial I}{\partial j} = \begin{matrix}- 1 & 0 & 1 \\ - 2 & 0 & 2 \\ - 1 & 0 & 1\end{matrix} \frac{\partial I}{\partial K} = \begin{matrix}- 1 & - 2 & - 1 \\ 0 & 0 & 0 \\ 1 & 2 & 1\end{matrix}$$

∂I/∂j and ∂I/∂k represent the partial derivatives of I (the brightness function associated with a particular pixel) with respect to pixel rows and column of pixels, respectively. ∂I/∂j can be calculated using finite differential techniques by measuring the brightness intensity function for pixels (j,k), (j+1,k), (j−1,k), and if desired, other pixels in row k (such as (j+2, k−1) and (j−2,k+1)). Similarly, ∂I/∂k can be determined by measuring the brightness intensities of pixels (j,k), (j,k+1), (j,k−1), and optionally other pixels along column j. A 2×2 Hessian matrix of second partial derivatives can be calculated for each pixel, established using the relationships

$$H = \frac{{\partial }^{2} I}{{\partial }_{j} {\partial }_{k}} ; \frac{{\partial }^{2} I}{\partial {j}^{2}} = \frac{\partial }{\partial j} \frac{\partial I}{\partial j} ; \frac{{\partial }^{2} I}{\partial jk} = \frac{{\partial }^{2} I}{\partial kj} = \frac{{\partial }^{2} I}{\partial k \partial j} ; \frac{{\partial }^{2} I}{\partial {k}^{2}} = \frac{\partial }{\partial k} \frac{\partial I}{\partial k} ;$$

For each image point that exceeds a brightness threshold (relative to the average of local pixels, such as 5% brighter or more than the local average), eigenvalues and eigenvectors of the Hessian matrix are evaluated. The eigenvalues represent the maximum and minimum rate of curvature of the brightness function near each point. Points exhibiting larger differences between the maximum and minimum rates of curvature of the brightness function are identified as potential points on the imaged ring. The eigenvectors indicate the directions of maximum and minimum rate of change of curvature near that point. The direction of maximum rate of curvature can be taken as a radius of a circle containing that point. As a further test, pixel values can be interpolated using a cubic spline model, along a short line segment in the direction of maximum curvature. A pixel is identified as imaging a point on the ring if the interpolated pixel value has a maximum closer to that pixel than the neighboring pixels. These methods allow the identification of pixel locations imaging points on the ring. Application of the cubic spline method allows the point to be identified to an accuracy of much less than one pixel. Points identified in this manner are then identified and the direction normal to that point is determined from the eigenvector.

Rings can be identified by the points identified in this manner using a generalization of the Hough transform technique as is described in Machine Vision: Theory, Algorithms, Practicalities, 2^{nd} Ed., E. R. Davies, Academic Press, San Diego 1997. Once candidate ring points are identified, a set of possible ring locations (centers) and radii (or other size metric) is established, and a counter for each of these is set to zero. As each ring point is identified, the counter for each possible ring that could contain the point is incremented. After all points have been processed, the counters are scanned to find maxima. Maxima indicate rings that are actually present in the image.

Direct pattern matching and edge following techniques are also useful to identify the rings. Such methods are described, for example, in Machine Vision: Theory, Algorithms, Practicalities, mentioned above. These techniques are less preferred when only parts of the rings are imaged, or when rings from different point sources intersect. These methods allow range calculations to be generated by presupposing a range for the point light source, and calculating the imaged ring or disk that corresponds to the point light source. If the calculated image matches the actual image, the presupposed range is confirmed. By repeating the matching process using many presupposed range estimates, the range of the point light source can be estimated accurately by finding the best match between the actual and calculated images.

The rings so identified can be characterized by geometric parameters applicable with the particular ring shape. Rings that are approximately circular or elliptical can be parameterized by describing them as a curve of the form
cu′²+du′v′+ev′²=1 (Equation 1)
The center can be designated with respect to the same coordinate system by the parameters (a, b). u′ and v′ define pixel coordinates relative to center a, b by u′=x′−a and v′=y′−b. c, d and e are constants encoding the lengths of major axis and minor axis and orientation of these axes with respect to the x,y coordinate system. In the case where the ring is circular, the value of d will be zero and c=e=1/r². Measurement of x, y and z occurs by estimating values of a, b, c, d and e from the image and using a calibration function to correlate the estimated values of a, b, c, d and e to values of x, y and z. One effective calibration function has the form

$$x = {\sum }_{α , β , γ , δ , ɛ} {f}_{α , β , γ , δ , ɛ} {a}^{α} {b}^{β} {c}^{γ} {d}^{δ} {ⅇ}^{ɛ} , \\ y = {\sum }_{α , β , γ , δ , ɛ} {g}_{α , β , γ , δ , ɛ} {a}^{α} {b}^{β} {c}^{γ} {d}^{δ} {ⅇ}^{ɛ} , \\ z = {\sum }_{α , β , γ , δ , ɛ} {h}_{α , β , γ , δ , ɛ} {a}^{α} {b}^{β} {c}^{γ} {d}^{δ} {ⅇ}^{ɛ} \qquad ( Equations II )$$

where the indices α, β, γ, δ and ε take on the values 0, 1 and 2 and the constants f, g and h represent the lens and camera calibration. With this set of parameters, the lens is represented by 729 constants, 243 each for the expressions for x, y and z. Calibration is performed by making multiple observations of light point sources having known x, y and z positions. Using a function of this form, the estimated values of a, b, c, d and e for each ellipse are compared with the known x, y and z distances of the light point source corresponding to that ellipse, and values of the constants f, g and h are calculated. For any observation i in which the point light source is at position (xᵢ, yᵢ, zᵢ), observed ellipse parameters can be designated (aᵢ, bᵢ, cᵢ, dᵢ and eᵢ). For sets of indices (α, β, γ, δ, ε) numbered j, for 1≦j≦243, the basis function (a^{α}, b^{β}, c^{γ}, d^{δ}, e^{ε}) can be denoted qⱼ(a,b,c,d,e). Equations II expressed for observation i then become

$${\sum }_{j = 1}^{243} {q}_{j} ( {a}_{i} , {b}_{i} , {c}_{i} , {d}_{i} , {e}_{i} ) {f}_{i} = {x}_{i} \\ {\sum }_{j = 1}^{243} {q}_{j} ( {a}_{i} , {b}_{i} , {c}_{i} , {d}_{i} , {e}_{i} ) {g}_{i} = {y}_{i} \\ {\sum }_{j = 1}^{243} {q}_{j} ( {a}_{i} , {b}_{i} , {c}_{i} , {d}_{i} , {e}_{i} ) {h}_{i} = {z}_{i} \qquad ( Equations III )$$

A 243×N matrix Q with element i,j given by qⱼ(aᵢ, bᵢ, cᵢ, dᵢ, eᵢ) taking the form
Q\vec{f}=\vec{x} Q\vec{g}=\vec{y} Q\vec{h}=\vec{z} (Equations IV)
can be used to estimate column vector f, g and h by solving equations IV in the least-squares sense, such as by finding the least-squares solution of the minimum norm using the Moore-Penrose generalized inverse of Q.

Once the constants are determined, positions of light sources of unknown position can be estimated using the calculated constants and values of a, b, c, d and e that are obtained from the imaged ring corresponding to that point light source.

The foregoing method works well even when only part of a ring is imaged, such as near the edge of the CCD.

Other methods of calculating range and position can also be used. In the case where the point source is imaged as a circular ring, the range and transverse position of the light source can be expressed in an x,y,z coordinate system using the following relationships:

$$z = \frac{{z}_{e} {r}_{d} f}{{r}_{d} f - {rz}_{e}} , x = {x}^{′} z ( \frac{1}{f} - \frac{1}{{z}_{e}} ) , y = {y}^{′} z ( \frac{1}{f} - \frac{1}{{z}_{e}} ) \qquad ( Eq . V )$$

wherein z is the range of the point light source, x is the distance of the light source along a first axis transverse to the optical axis of the camera (first transverse axis), y is the distance of the light source from a second axis that is transverse to the optical axis and orthogonal to the first transverse axis (second transverse axis), zₑ is the distance from the focal plane of the lens to the image sensor, f is the focal length of the lens, r is the diameter of the ring, and r_{d} is the diameter of the exit pupil of the lens. x′ and y′ represent the position of the center of the ring on the image sensor relative to the optical axis of the camera, along the first and second transverse axes.

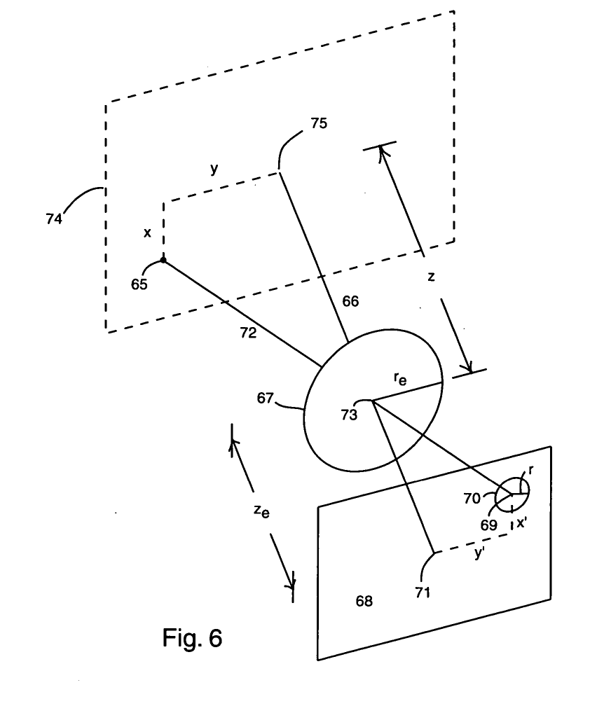

This relationship is diagrammed in FIG. 6. In FIG. 6, point light source 65 is located a distance x from camera optical axis 66 along a first transverse axis and a distance y from optical axis 66 along a second transverse axis. The field of view of the camera is indicated by dotted line 74. Optical axis 66 passes from center point 75 of the field of view, through center point 73 of lens 67 to the center 71 of CCD 68. Light rays from point light source 65 pass through center 73 of lens 67 and are imaged as a circular ring 70 centered at point 69. Point 69 is distance x′ from center 71 of CCD 68 along the first transverse axis and distance y′ from center 71 of CCD along the second transverse axis. Circular ring 70 has diameter r and lens 73 has aperture rₑ, which is typically defined by an exit pupil. The distance from the focal plane of lens 67 to CCD 68 is zₑ; the range of point 65 along optical axis 66 from the focal plane of lens 67 is z.

Thus, in the case where the point source is imaged as a circle, range and position estimates can be calculated directly once r is determined, using known values for the lens focal length, aperture and focus setting. This method can also be generalized to accommodate other ring shapes, such as ellipses. This method is most useful when the focal length, position of the image sensor and aperture diameter are accurately known, and when image distortion is minimal.

The method can be used in static or dynamic applications. Dynamic applications involve capturing a number of successive images, each including a common light source, at known time intervals. Estimated positional changes in the light source between successive images are used to calculate the speed and direction of the point light source relative to the camera. In dynamic applications, the exposure time must be short enough that blurring is minimized, as blurring introduces error in locating the positions of the rings on the image sensors. In addition, the interval between exposures is preferably short to increase accuracy.

The method of the invention is suitable for a wide range of applications. In a simple application, the range information can be used to create displays of various forms, in which the range information is converted to visual or audible form. Examples of such displays include, for example:
(a) a visual display of the scene, on which superimposed numerals represent the range of one or more objects in the scene;
(b) a visual display that-is color-coded to represent objects of varying distance;
(c) a display that can be actuated, such as, for example, operation of a mouse or keyboard, to display a range value on command;
(d) a synthesized voice indicating the range of one or more objects;
(e) a visual or aural alarm that is created when an object is within a predetermined range.

In any case, once range and position information has been established for light point sources within a scene, the information can be converted into a file format suitable for 3D computer-aided design (CAD). Such formats include the “Initial Graphics Exchange Specifications” (IGES) and “Drawing Exchange” (DXF) formats. The information can then be exploited for many purposes using commercially available computer hardware and software. For example, it can be used to construct 3D models for virtual reality games and training simulators. It can be used to create graphic animations for, e.g., entertainment, commercials, and expert testimony in legal proceedings. It can be used as topographic information for designing civil engineering projects. A wide range of surveying needs can be served in this manner.

In factory and warehouse settings, it is frequently necessary to measure the locations of objects such as parts and packages in order to control machines that manipulate them. The method of the invention can be used for such purposes. In such an application, light sources are installed in known positions to serve as guides. The operation of machinery is controlled using the invention by controlling distances and speeds relative to the measured positions of the guide lights.

The measured position of guide lights can be used in similar manner to control a mobile robot. The positional information is fed to the controller of the robotic device, which is operated in response to the range information. An example of a method for controlling a robotic device in response to range information is that described in U.S. Pat. No. 5,793,900 to Nourbakhsh, incorporated herein by reference. Other methods of robotic navigation into which this invention can be incorporated are described in Borenstein et al., Navigating Mobile Robots, A K Peters, Ltd., Wellesley, Mass., 1996. Examples of robotic devices that can be controlled in this way are automated dump trucks, tractors, orchard equipment like sprayers and pickers, vegetable harvesting machines, construction robots, domestic robots, machines to pull weeds and volunteer corn, mine clearing robots, and robots to sort and manipulate hazardous materials.

Another application is in dynamic crash testing. This can be done by attaching point light sources to a part, placing the part in the view of a camera as described above, and taking images of the part as it undergoes the crash test. The camera is generally mounted in a fixed position on the object undergoing the test. For this application, very short exposure times and very short intervals between frames are particularly useful. The range and optionally position of the point light sources is identified in a series of two or more images. Changes in range and/or position indicate the direction and speed of motion of the part, relative the camera, during the test. An example of this application is the observation of toe pan deformation in an automotive dynamic test. Point light sources are mounted on the toe pan, or on a panel mounted over the toe pan. The point light source may emit light or reflect light provided by a light source. A convenient illumination method is to use small, highly reflective surfaces as the point light sources, and to illuminate these with a bright light coming from the general direction of the camera. The camera is mounted on some fixed structure in the vehicle, such as a driver or passenger seat, takes images of the point light sources as the test is performed. Changes in position of the point light sources indicate the deformation of the toe panel during the test.

The following examples are provided to illustrate the invention but not to limit the scope thereof.

### EXAMPLE 1

A target is prepared by arranging 10, 5-mm silver plated balls in a line on a support, with a spacing of about 18 mm. The target is positioned with its center 1200 mm from the lens of a Canon XL1 video camera with an f/1.8 Nikkor 24 mm lines. The target is angled to produce a ˜3 mm difference in the distance from the lens (measured along the optical axis of the camera) for successive balls on the target. The lens is focused to zₑ (distance to focal plane)=426 mm. The aperture is estimated at r_{d}=8.5 mm, and the focal length is approximately 25 mm. At this focusing, the balls are imaged as bright rings on the camera's CCD due to undercorrected spherical aberration of the lens. An image of the target is recorded. The image is processed by applying a smoothing operator followed by convolution with a Laplace operator. This isolates the perimeters of the blur circles as well-defined rings. Each ring is then fit to a model circle, by minimizing the sum of the squares of the differences between the filtered pixel values and expected values for each test ring. This establishes a center point and radius for each ring. The radii of the imaged rings range from 45.712 pixels to 46.307 pixels. Ball positions are calculated using the relationships expressed in Equations V above.

Results are summarized in Table 1, in which x- and y-positions are measured from the optical axis of the camera, with positive x being to the right and positive y being up.

TABLE 1

| | X distance (mm) | | Y distance (mm) | | Z distance (mm) | |
|---|---|---|---|---|---|---|
| Ball No. | Measured | Error | Measured | Error | Measured | Error |
| 1 | −68.27 | 0.57 | 1.20 | 0.27 | 1185.49 | 0.68 |
| 2 | −50.20 | 0.81 | −0.60 | 0.33 | 1188.42 | 0.61 |
| 3 | −33.21 | −0.03 | −2.25 | 0.023 | 1190.35 | −0.46 |
| 4 | −14.83 | 0.52 | −3.31 | 0.46 | 1192.76 | −1.05 |
| 5 | 2.57 | 0.10 | −5.38 | 0.13 | 1192.56 | −4.25 |
| 6 | 19.91 | −0.39 | −7.25 | 0.02 | 1199.86 | 0.05 |
| 7 | 37.39 | −0.74 | −8.77 | 0.24 | 1204.79 | 1.99 |
| 8 | 55.38 | −0.57 | −10.53 | 0.23 | 1205.70 | −0.11 |
| 9 | 72.95 | −0.84 | −12.50 | −0.01 | 1209.49 | 0.69 |
| 10 | 92.18 | 0.57 | −14.53 | −0.27 | 1213.66 | 1.85 |

Rms errors in x, y and z are 0.58, 0.25 and 1.68 mm, respectively. The x and y errors are believed to be dominated by ball placement errors. The rms error in z is 1.68/˜1200, or approximately 0.14%.

### EXAMPLE 2

A Nikon 35 mm, f/1.4 lens is fitted with a 0.5 magnification wide angle adapter to produce a 17.5 mm, f/2.8 lens. This lens has a special focusing mechanism in which the rear group of lens elements moves in relation to the front group when the lens is focused. The rear elements are removed from the lens and a masked glass plate is inserted adjacent to the iris. The glass plate is masked in black except for an annular ring that is 20 mm in diameter and 1 mm wide. This rings causes out-of-focus point sources to be imaged as bright rings due to diffraction. The lens is mounted on a Nikon D1H camera. This camera has a 2000×1312 pixel CCD. The camera is mounted on a vertically adjustable stand and pointed downward over the center of a calibration plate and target plates as described below.

A five-ring target plate (a half-size version of the standard (ISO 8721/SAEJ211/2 Optical Calibration Target for automobile crash testing) is constructed by drilling conical holes into a ½ inch aluminum plate. The holes are arranged in five circles of 16 approximately equally spaced holes each, with a 17^{th} hole marking the center of each circle. The holes are distributed over an area of 625×460 mm. The plate is placed horizontally on a flat surface.

A calibration plate is prepared by drilling 9 rows of 13 small holes each into a ¾″ (18.5 mm) sheet of plywood, to form a total square grid of 117 holes spaced 50 mm apart. This calibration plate is laid atop the target plate. Nickel-plated ball bearings of 0.250±0.004 inch diameter are placed in each of the holes, so that the ball bearings protrude from the face of the aluminum plate by about the radius of the ball (˜0.125 in). A spotlight is shined onto the surface of the balls from a height somewhat above the level of the camera. Light from the spotlight is reflected by the balls into the camera to create point light sources.

Images of the calibration plate are taken at camera heights of 510, 610, 710, 810 and 910 mm from the front of the lens. The position of each ball relative to the optical axis of the camera is known. At closer distances, not all balls are within the field of view of the camera. The camera is focused at about 300 mm. At this focus setting, the balls are imaged as bright somewhat elliptical rings due to diffraction effects.

At total of 490 of the rings are analyzed. Rings are identified based on a generalization of the Hough transform technique described above. An average of 575 ridge points are identified per reflected ball using this technique. The radii measurements made in this manner are expected to produce an error of approximately 0.03 pixels.

The points so identified are fitted to model ellipses having parameters a, b, c, d and e, using methods as described above. The measured parameters a, b, c, d and e are calibrated to known values of x, y and z for the corresponding balls, using a calibration function having the form of equation IV above, and values for f, g and h in those equations are calculated.

Nine mages of the 5-ring target plate are then taken with the camera, using the same settings and procedure as before. Nickel balls are described before are placed into the holes in the target to emulate point light sources. The target plate is at distances of 528.5, 578.5, 628.5, 678.5, 728.5, 778.5, 828.5, 878.5 and 928.5 mm, respectively, as these images are taken. The balls are imaged as rough ellipses on the image sensor. Values a, b, c, d and e of the ellipses are determined as before. For each ring, these values, plus the previously established values of f, g and h, are inserted into the calibration function and used to estimate x, y and z for each ball imaged.

Calculated values of x, y and z compare to actual values as set forth in Table 2. Bias errors are calculated by averaging the difference between measured and actual values over the number of observations at each distance. Standard deviations, after removing the bias, are calculated and are as reported in Table 2.

TABLE 2

| | | x | | y | | z | |
|---|---|---|---|---|---|---|---|
| z (actual), | No. balls | Bias | Std. | Bias | Std. | Bias | Std. |
| mm | imaged | Error | Dev. | Error | Dev. | Error | Dev. |
| 528.5 | 38 | −1.61 | 2.02 | 1.01 | 1.32 | −2.65 | 5.15 |
| 578.5 | 45 | −0.95 | 2.33 | 0.79 | 0.84 | −0.10 | 3.85 |
| 628.5 | 53 | 0.10 | 1.84 | 0.56 | 1.09 | 0.62 | 2.60 |
| 678.5 | 57 | 0.11 | 1.80 | 0.47 | 1.15 | 0.69 | 2.57 |
| 728.5 | 60 | −0.34 | 0.71 | 0.51 | 0.59 | 0.75 | 2.31 |
| 778.5 | 66 | −0.79 | 1.02 | 0.37 | 0.62 | 0.13 | 2.26 |
| 828.5 | 75 | −0.36 | 1.08 | 0.37 | 0.86 | 0.45 | 3.88 |
| 878.5 | 79 | 0.28 | 1.28 | 0.52 | 0.85 | −1.70 | 4.96 |
| 928.5 | 82 | 0.61 | 1.07 | 0.56 | 0.68 | −0.47 | 3.80 |

Excellent estimates of x, y and z are obtained at all measured distances. In particular, the error in z is well less than 0.5% at all distances measured. An examination of the errors as a function of transverse position shows that the points on the outside of the images have the largest deviations. This may be due to aberration in the wide angle adapter.

### EXAMPLE 3

A Nikon 20 mm, f/2.8 lens is mounted on a NAC Memrecam K3 high speed digital camera. This lens has undercorrected spherical aberration, and in that manner images out-of-focus point sources as ellipses. This lens has a rear group of lens elements that moves in relation to the front group when the lens is focused. The lens has a focusing mechanism that allows both groups of lenses to be adjusted by turning a single focusing ring. This mechanism is defeated so each group of lenses can be moved independently. This allows some astigmatism to be eliminated by independent adjustment of the two groups of lenses. Removal of the astigmatism allows point sources to be imaged nearly as regular ellipses. This camera has a 1280×1024 pixel CCD. Pixel size is 12 μm.

The camera is used to take images of the calibration target in the general manner described in Example 2. These images are used to calculate values of the coefficients f, g and h that are used to correlate image locations with x, y and z estimates for the point light sources. Once the system is calibrated, images are taken of the target plate at distances of 450, 550, 650, 750 and 850 mm. The balls are imaged as ellipses on the image sensor. Values a, b, c, d and e of the ellipses are determined as before. For each ring, these values, plus the previously established values of f, g and h, are inserted into the calibration function given above and used to estimate x, y and z for each ball imaged. Results are as indicated in Table 3.

TABLE 3

| | | x | | y | | z | |
|---|---|---|---|---|---|---|---|
| z (actual), | No. balls | Bias | Std. | Bias | Std. | Bias | Std. |
| mm | imaged | Error | Dev. | Error | Dev. | Error | Dev. |
| 450 | 23 | −0.055 | 0.839 | 0.014 | 0.483 | −0.192 | 1.718 |
| 550 | 32 | −0.005 | 1.141 | −0.016 | 0.500 | 0.166 | 2.437 |
| 650 | 40 | −0.219 | 0.975 | 0.159 | 0.485 | −1.313 | 3.139 |
| 750 | 50 | −0.272 | 1.298 | 0.334 | 0.597 | −0.381 | 3.701 |
| 850 | 55 | −0.499 | 1.665 | 0.703 | 0.757 | 0.134 | 5.372 |

Again, excellent correlation between actual and estimated distances is obtained.

### EXAMPLE 4

The camera and lens system described in Example 3 is tested in a dynamic situation. To form a target that moves in a known manner, two ball bearings as described in Example 2 are glued to the end of a grinder attachment for a Dremel® high speed rotary tool. One of the balls is painted black, so it does not reflect light and thus serves merely as a counterweight to balance the tool. The camera is mounted so that the camera's optical axis and the power tool axis of rotation are roughly aligned. This permits the ball bearings to move transversely with respect to the camera while holding the range, z, constant at 394 mm. The balls are illuminated using Meggaflash™ PF330 flash bulbs, which produce approximately 80,000 lumens for 1.75 seconds. A conical reflector directed the light produced by the flash bulbs onto the rotating ball from a distance of about 200 mm. Images are taken at 2000 frames/second with exposure times of 1/5000 second. At this speed, half frames of 1280×512 pixels are exposed. Images are taken at various rotation speeds, which are controlled by varying input voltage to the power tool. For each condition, 256 frames of video are captured and analyzed. For each frame, x, y and z values are estimated, using the calibration values produced in Example 3. The rotational amplitude of the rotating ball bearing is calculated in each of the x, y and z directions (Aₓ, A_{y} and A_{z}, respectively). Results are as in Table 4.

TABLE 4

| | | | | | | Std. |
|---|---|---|---|---|---|---|
| Rotation | Linear | | | | Ave. z, | Dev., |
| Rate, Hz | Speed, mph | Aₓ, mm | A_{y}, mm | A_{z}, mm | mm | mm |
| 72.7 | 3.1 | 3.064 | 2.920 | 0.098 | 394.385 | 0.325 |
| 91.2 | 3.8 | 3.001 | 2.978 | 0.092 | 394.016 | 0.341 |
| 199.9 | 8.4 | 2.978 | 2.933 | 0.086 | 390.503 | 0.346 |
| 226.4 | 14.2 | 2.925 | 2.911 | 0.146 | 386.551 | 0.817 |
| 405.8 | 17.1 | 2.985 | 3.074 | 0.381 | 379.049 | 2.332 |

The near agreement in Aₓ and A_{y} values at all rotation rates indicates good agreement with actual values. The error in the z measurement increases with faster rotational rates. This is believed to be due to image blurring, and can be overcome by using more light and shorter exposure times.

It will be appreciated that many modifications can be made to the invention as described herein without departing from the spirit of the invention, the scope of which is defined by the appended claims.

1. A method for determining the range of one or more point light sources, comprising
(a) forming an out-of-focus image of the point light source on an image sensor of a camera, such that the point light source is imaged at a position on the image sensor as a predetermined form having a distinct periphery, and
(b) calculating an estimated range of the point light source from the image of the point light source on the image sensor.

2. The method of claim 1, wherein the point light source is imaged as a disk or ring having a bright periphery.

3. The method of 2, wherein the image of the point light source is identified by processing the image to locate regions corresponding to the bright periphery of the disk or ring.

4. The method of claim 3, wherein the estimated range is calculated by determining at least one size metric of the disk or ring and calculating the range of the point light source from said size metric.

5. The method of claim 3 wherein the camera has a lens that causes spherical aberration that forms the bright periphery of the disk or ring.

6. The method of claim 5 wherein the spherical aberration is undercorrected.

7. The method of claim 5 wherein the spherical aberration is overcorrected.

8. The method of claim 3 wherein the bright periphery of the disk or ring is created by diffraction created at an aperture of a lens of the camera.

9. The method of claim 4 wherein a position of the point light source transverse to an optical axis of the camera is estimated from the position of the imaged disk or ring on the image sensor.

10. The method of claim 3, wherein the range of the point light source is estimated by developing a plurality of postulated ranges for the point light source, calculating a corresponding hypothetical image on the image sensor for each postulated range, comparing the hypothetical image with the actual image corresponding to the point light source, identifying a hypothetical image that matches most closely with the actual image, and assigning a range value of the point light source equal to that of the postulated range that corresponds to the hypothetical image that matches most closely with the actual image.

11. The method of claim 10 wherein the camera has a lens that causes spherical aberration that forms the bright periphery of the disk or ring.

12. The method of claim 11 wherein the spherical aberration is undercorrected.

13. The method of claim 11 wherein the spherical aberration is overcorrected.

14. The method of claim 10 wherein the bright periphery of the disk or ring is caused by diffraction effected created by the interaction of light from the point light source with an aperture of a lens of the camera.

15. The method of claim 10 wherein a position of the point light source transverse to an optical axis of the camera is estimated from the position of the imaged disk or ring on the image sensor.

16. A camera comprising a lens and an image sensor, wherein the lens is capable of forming an out-of-focus image of a remote point light source such that the point light source is imaged on the image sensor as a predetermined form having a distinct periphery, and computer means for identifying said image and calculating an estimate of the range of the point light source from the image.

17. The camera of claim 16, wherein the point light source is imaged as a disk or ring having a bright periphery.

18. The camera of claim 17, wherein the lens creates undercorrected spherical aberration that produces an image of the point light source on the image sensor as a disk or ring having a bright periphery.

19. The camera of claim 17, wherein the lens creates overcorrected spherical aberration that produces an image of the point light source on the image sensor as a disk or ring having a bright periphery.

20. The camera of claim 17, wherein the bright periphery of the disk or ring is caused by diffraction effected created by the interaction of light from the point light source with an aperture of the lens.
